(19) United States
(12) Patent Application Publication
(10) Pub. No.: US 2023/0126016 A1
(43) Pub. Date: Apr. 27, 2023

(54) TOKENIZATION OF COLLECTIBLES AND RELATED METHODS

(71) Applicant: Collectors Universe, Inc., Santa Ana, CA (US)

(72) Inventor: John Nelson, Trabuco Canyon, CA (US)

(73) Assignee: Collectors Universe, Inc., Santa Ana, CA (US)

(21) Appl. No.: 18/049,776

(22) Filed: Oct. 26, 2022

Related U.S. Application Data
(60) Provisional application No. 63/272,483, filed on Oct. 27, 2021.

(51) Int. Cl. H04L 9/32; G06Q 30/02

(52) U.S. Cl. CPC H04L 9/3213; G06Q 30/0278; H04L 2209/60; H04L 2209/80

(57) ABSTRACT

A system and method for generating non-fungible tokens for collectibles. The system authenticates physical ownership of a collectible before allowing a requesting entity to generate a non-fungible token for the collectible. The system generates a fiat currency value for the non-fungible token based on the total number of non-fungible tokens already generated for the collectible and the current value of the collectible. The system tracks non-fungible tokens generated for the collectible to ensure that the proportional cost of generating a non-fungible token strictly increases as the total number of non-fungible tokens generated for the collectible increases.

### CROSS-REFERENCE TO RELATED APPLICATIONS

This is a regular utility of provisional application Ser. No. 63/272,483, filed Oct. 27, 2021, the contents of which are expressly incorporated hereby reference as if set forth in full.

### FEDERALLY SPONSORED RESEARCH OR DEVELOPMENT

Not Applicable

### BACKGROUND

Rare goods, like baseball cards, may provide a monetary value proportionate to their quality and rarity. Various organizations exist that certify such goods, which can increase and solidify their value in a community. However, purchasing and selling such goods at a venue like an auction may be inconvenient and infrequent. While such auctions and transactions may also be performed online, consumer confidence in such online transactions are low without some accountability mechanisms in place. Moreover, collectible goods are generally only sold as a single unit, and generally cannot be shared if multiple entities wish to purchase a single collectible.

It would therefore be desirable to have improved systems and methods for buying and selling collectibles.

### SUMMARY

Systems and methods for generating non-fungible tokens (NFTs) for a collectible are disclosed. The system may be configured to allow an owner of a collectible card to generate, at any time, an NFT based on a percentage of the current value of the card and a number of NFTs generated for the card. For example, a first NFT for a card may be generated at a cost of 1% of the value of the card at that time, which may be, as an example, $100,000, and thus the system may charge an owner of the card $1,000 to generate the first NFT. A second NFT for the same card may be generated at a cost of 2% of the value of the card at that time, which may be $80,000, and thus the system may charge $1,600 to generate the second NFT. A third NFT for the same card may be generated at a cost of 3% of the value of the card at that time, which may be $120,000, and thus the system may charge $3,600 to generate the third NFT. Once created, the NFTs may be digital-only assets that may be traded independently from the collectible on any suitable platform that allows transactions of an NFT using a blockchain network, such as Ethereum'S™ OpenSea™ platform.

The collectibles may be graded by an entity, such as a Professional Sports Authenticator (PSA), which may mint a collectible by assigning a unique identifier to the collectible that uniquely identifies the collectible from similar collectibles. A set of metadata specific to the collectible may also be associated with the collectible. For example, a collectible basketball card may be assigned a barcode unique identifier, which may be read by a barcode reader to retrieve a set of metadata about the card, such as the PSA grade, any imperfections the card may have, and the current known owner of the card. Additionally or alternatively, an NFC (Near Field Communication) device may be programmed to wirelessly transmit data associated with the card to a device programmed to receive the transmission. For example, an EEPROM chip may be sealed in a package with the card, and may be read by an NFC tag reader, which may retrieve a unique identifier for the card along with some metadata about the card. Minting a collectible may comprise sealing an indicator of the grade and a unique identifier (e.g., an NFC tag) with the collectible in a sealed case for the collectible, which prevents tampering of the indicator without damaging the case, and possibly the collectible.

When an entity that owns a collectible wishes to generate a token for a collectible, the entity may make a request of the system to do so, for example by activating a user interface on mobile phone device or a website portal to send a command to generate an NFT for a selected collectible. The system may authenticate whether the entity physically owns the collectible using a vault authentication device. A vault authentication device may be any suitable device functionally connected to the system that allows the system to determine if the entity physically owns the collectible, for example a mobile device that reads an NFC tag embedded in a sealed collectible case, or a vault having a dynamic electronic inventory of collectibles that are stored in the vault. The system may also authenticate the entity against a user database, such as a unique username and a corresponding password, which may be used to correlate the entity with a blockchain network address, such as an Ethereum™ address. The term entity used herein can be a natural person or a juridical entity.

Once the system has verified that the requesting entity physically possesses the collectible, the system may then proceed to valuate the cost of generating an NFT. The system may valuate the cost of generating an NFT in any suitable manner, such as by generating a fiat currency value for generating the new NFT as a function of the number of previously generated tokens for the authenticated collectible and the current value of the collectible. For example, where the number of previously generated tokens is x and the current value of the collectible is y, the cost of generating an NFT may be calculated as x %*y, such that the first generated NFT may be valuated at 1% of y, the second generated NFT may be valuated at 2% of y, the third generated NFT may be valuated at 3% of y, and so on. The value of generating a new NFT for a collectible may exceed the value of the collectible when the number of previously generated tokens exceeds a threshold value. For example, with the previous x %*y example, after 100 NFTs have been generated for the collectible, the price to generate a new NFT will exceed the current market value of the collectible, which naturally limits the number of NFTs that may be generated for a collectible using market forces. The current value of the collectible may be determined in any suitable manner, for example by retrieving the current market value from a collectible value database, such as a grading service. The current value of the collectible may be calculated as a function of an assigned grade of a collectible minted by an authorized grading service, such as PSA, that is recognized by the system.

The system may track NFTs that have been previously generated for the collectible in any suitable manner, for example by using a non-fungible token database (NFT database) that tracks tokens that are generated for a unique collectible, or by recording token generations within one or more blockchain ledgers. When an NFT is generated, the system may be configured to update the NFT database with metadata regarding the NFT generation, such as how many NFTs were created for each unique collectible identifier in the database, or which entity owns each NFT generated for a collectible. Alternatively, when an NFT is generated, the system may be configured to update a parent NFT for the collectible (i.e., the first NFT generated for the collectible), or may be configured to update all NFTs generated for the collectible thus far, allowing the blockchain network to act as a recordkeeper for collectible NFTs.

The system may provide the valuation to generate the NFT to the entity, who may then trigger generation of the NFT by paying the valuation cost. Such a valuation cost may be paid in any suitable manner, for example by paying a fiat currency value, or by paying an equivalent cryptocurrency value, to the system. The system may then receive a transaction receipt verifying that the payment was made, and then may generate the NFT for the collectible in a blockchain network, such as Ethereum™. The system may then update an NFT database with a new total number of NFTs generated for the collectible, which may increase the cost to generate an NFT in the future. The new NFT may be generated as being owned by the entity that physically possesses the collectible, or may be generated as being owned by an originator, who then may transfer ownership of the NFT to the entity that physically possesses the collectible. Once the new NFT is generated, the NFT may be purchased, sold, or traded via a blockchain network using any suitable means.

The system may be configured to generate NFTs to hold additional metadata in a ledger for the NFT, such as a set of metadata about the qualities of the collectible (e.g., a PSA value), recertifications of the collectible, or changes of ownership of the NFT. An NFT may be generated to have a contract that automatically transfers a portion of a transaction price to an originator account whenever the NFT is transferred to a new owner. For example, a contract for an NFT may require 10% of the transaction price to an originator account on the blockchain every time the NFT transfers ownership. Other contracts are also envisioned, such as contracts to update a parent NFT when the NFT transfers ownership, or contracts to update all known NFTs when the NFT transfers ownership. An NFT may also comprise one or more metadata flags that are set as a function of a random number generator. For example, an NFT may comprise a blue border flag that may have a 1/10 chance of activating when the NFT is generated, or may comprise a gold border flag that may have a 1/100 chance of activating when the NFT is generated.

The system may be configured to enable an entity that owns multiple NFTs in a blockchain network to redeem the NFTs for a collectible. For example, an entity that owns all of the NFTs for a collectible (e.g., 35 NFTs were generated for a collectible and the entity owns all 35 NFTs), may be able to redeem the NFTs for the collectible. The system may receive a request for delivery of a collectible from an entity, and may be provided authentication information in a ledger of a blockchain network that verifies that the entity requesting delivery of the collectible owns every NFT generated for the collectible. The system may then deliver the collectible to the entity, such as by physically handing the collectible to the entity, or by electronically transferring ownership of the collectible in a database, such as a vault database for a physical vault that holds a plurality of collectibles.

A still further aspect of the invention is a method of generating a non-fungible token (NFT) for a collectible. The collectible can be any number of item of monetary value. Exemplary collectible items are those that are conducive to storage in a case along with identification markers and/or generators for uniquely identifying the housed collectible. The method can comprise: receiving a request to generate a token for the collectible from a requesting entity; authenticating physical ownership of the collectible by the requesting entity using a vault authentication device; retrieving a number of previously generated tokens for the authenticated collectible from a non-fungible token database; retrieving a current value of the collectible from a collectible value database; generating a fiat currency value of the non-fungible token as a function of the number of previously generated tokens for the authenticated collectible and the current value of the collectible; generating the non-fungible token in a blockchain network as a function of the fiat currency value; incrementing the number of previously generated tokens for the authenticated collectible in the non-fungible token database; and assigning digital ownership of the non-fungible token to the requesting entity in the blockchain network.

In some examples, the number of previously generated tokens for the authenticated collectible is zero. However, the number can be any whole number greater than 1, such as greater than 10, greater than 100, and preferably greater than 200. The number of previously generated tokens for the authenticated collectible can be limited by the current value of the authenticated collectible and the price point per unit that the requesting party desires.

The method can further comprise authenticating the requesting entity in a collectible entity database that associates the requesting entity with an address in the blockchain network.

The vault authentication device can comprise a physical vault that dynamically records a presence of the collectable within the physical vault. In other examples, the physical vault can include manually upload-able tracking system for tracking each new collectable placed inside the vault.

The vault authentication device can comprise a wireless reader that records a unique identifier of an NFC (Near Field Communication) device embedded within a sealed case of the collectible.

The method of generating the fiat currency value can comprise an increased percentage of the current value of the collectible when the number of previously generated tokens increases.

The method of generating the fiat currency value can comprise generating a value higher than the current value of the collectible when the number of previously generated tokens exceeds a threshold value.

The method of generating the non-fungible token in the blockchain network can further include a URL that owns the NFT or that stores information about the NFT.

Information stored on the network can include a picture of the authenticated collectible. The picture can be a high resolution picture that allows for enlarging and inspecting.

The method can further comprise minting the collectible by assigning a grade and a unique identifier to the collectible and sealing an indicator of the grade and the unique identifier with the collectible in a sealed case for the collectable. An NFC chip can be embedded in the case with the collectable. The case can have one window, two windows, or more than two windows. The collectable and the identifier can be viewed through a respective window.

The method can further comprise generating a current value of the collectible as a function of the assigned grade of the minted collectible.

The step of generating the non-fungible token in the blockchain network can further comprise generating a contract for the non-fungible token that automatically transfers a portion of a transaction price to an originator account when the non-fungible token is transferred to a new owner.

The method can further comprise: receiving a request for the collectible from a delivery entity; authenticating digital ownership of a number of non-fungible tokens generated using the authenticated collectible against a ledger of the blockchain network; and delivering physical ownership of the collectible to the delivery entity upon authentication of the digital ownership.

A still yet further aspect of the invention includes a system for generating a non-fungible token for a unique collectible. The system for generating can comprise: a vault authentication device that authenticates physical ownership of the collectible by a requesting entity; a non-fungible token database that tracks non-fungible tokens generated for the collectible in a blockchain network, wherein each non-fungible token identifies an owner and the unique collectible that the non-fungible token is generated for; a non-fungible token generation system, configured to: authenticate physical ownership of the collectible by a requesting entity using the vault authentication device; retrieve a number of previously generated tokens for the authenticated collectible from the non-fungible token database; retrieve a current value of the collectible from a collectible value database; generate a fiat currency value of the non-fungible token as a function of the number of previously generated tokens for the authenticated collectible and the current value of the collectible; generate the non-fungible token for the unique collectible in a blockchain network as a function of the fiat currency value; associate the non-fungible token with the collectible in the non-fungible token database; and assign digital ownership of the non-fungible token to the requesting entity in the blockchain network.

The system can further comprise a collectible entity database that associates the requesting entity with an address in the blockchain network, wherein the vault authentication device authenticates the requesting entity using the collectible entity database.

The non-fungible token generation system can be configured to generate the fiat currency value of the non-fungible token as an increased percentage of the current value of the collectible when the number of previously generated tokens increases.

Yet another aspect of the invention includes a method of generating non-fungible tokens for a collectible. The method for generating can comprise: assigning a unique identifier to the collectible; sealing an NFC device within a sealed case that holds the collectible; authenticating physical ownership of the collectible at the first time by the requesting entity using a vault authentication device to retrieve the unique identifier from the NFC device; receiving a request to generate a first token for the collectible from a requesting entity at a first time; retrieving a first value of the collectible at a first time from a collectible value database; generating a first fiat currency value of the first non-fungible token as a function of a first percentage of the first value of the collectible; generating a first non-fungible token in a blockchain network upon receipt of a transaction receipt confirming payment of the first fiat currency value for the first non-fungible token; receiving a request to generate a second token for the collectible from the requesting entity at a second time; retrieving a second value of the collectible at a second time from the collectible value database; generating a second fiat currency value of the second non-fungible token as a function of a second percentage of the second value of the collectible, wherein the second percentage is larger than the first percentage; generating a second non-fungible token in the blockchain network upon receipt of a transaction receipt confirming payment of the second fiat currency value for the second non-fungible token.

The NFC device can further be configured to transmit a set of metadata associated with the collectible to the vault authentication device.

The generating of the first non-fungible token in the blockchain network can comprise recording the unique identifier and the set of metadata in a ledger for the first non-fungible token of the blockchain network.

The generating of the first non-fungible token in the blockchain network can comprise recording a number of non-fungible tokens created for the collectible in a ledger for the first non-fungible token of the blockchain network.

The generating of the second non-fungible token in the blockchain network can comprise recording a number of non-fungible tokens created for the collectible in a ledger for the first non-fungible token of the blockchain network and a ledger for the second non-fungible token of the blockchain network.

The generating of the first non-fungible token in the blockchain network can further comprise adding an upgrade metadata flag to a ledger for the non-fungible token as a function of a random number generator.

Other variations on the disclosed systems and methods are envisioned, as explained in the detailed description below.

### BRIEF DESCRIPTION OF THE DRAWINGS

FIG. 1 shows an exemplary collectible unit.

FIG. 2 shows an alternative collectible unit configured to communicate with a vault authentication device.

FIG. 3 shows a schematic of an exemplary NFT generation system for a collectible unit.

### DETAILED DESCRIPTION

The following detailed description describes systems and methods for generating non-fungible tokens (NFTs) for a collectible, among other things.

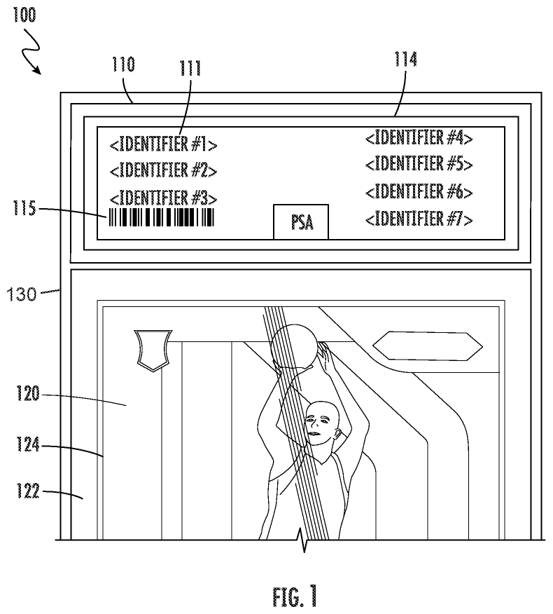

FIG. 1 shows a collectible unit 100 comprising a set of identifiers 110 and a collectible 120 sealed or secured within a case 130. The collectible 120 is shown in FIG. 1 as a collectible basketball player card, but may be any collectible that may be certified, such as a coin, a figurine, a limited edition or prized game card, a memorabilia, or an autograph, to name a few non-limiting examples. The case 130 may be configured to have one or more transparent windows 124 that allow a person to view portions or all of the collectible 120 while the collectible 120 is still sealed within the case 130. While two windows 124 are shown in FIG. 1, for the identifiers and for the card, the collectible unit 100 may have a plurality of windows on multiple sides of the case 130, such as a front window to view a front portion of the card and a rear window to view a rear portion of the card.

In some examples, a collectible unit 100 may have just a single window to show one portion of a collectible, such as a front surface of a media (e.g., a napkin, a photograph) where an autograph has been signed. The collectible may be vacuum sealed, such as in a clear housing, before placement into the case 130. Optionally, the case 130 itself may have a vacuum seal 122 about a perimeter, which may be configured to help preserve the quality of the collectible 120 that is sealed within the case 130. In still other examples, the collectible is placed inside the case without a separate seal or sleeve. The case 130 may be sealed with the collectible 120 located therein in any suitable manner, for example by heat-welding, by adhesive, by detents, to provide a secured unit that is difficult to separate or tempered with without destroying the case. By sealing the collectible 120 within a case 130, a certification entity, such as PSA and PCGS, may ensure that the collectible 120 is not damaged or otherwise compromised after minting or certification, which ensures that the quality of the collectible 120 is maintained so long as the case 130 remains intact. In some examples, the case 130 may have UV protection built into the front and rear sections of the case to protect the collectible from potential harmful UV rays.

The collectible unit 100 also comprises a set of identifiers 110 that have been sealed or secured within the case 130. While the set of identifiers 110 have been sealed within a separate compartment of the case 130 from the collectible 120, the set of identifiers 110 may be sealed within a common compartment of the case 130, or may be included in discrete sections of the collectible unit 100, such as a front side and a back side of the unit 100, or a top side and a bottom side of the unit 100.

In an example, the set of identifiers 110 comprises a set of human-readable identifiers 111, shown here as a set of alphanumeric text viewable through the window 114, and machine-readable identifiers 115, shown here as a barcode viewable through the window 114. The identifiers may be included in the collectible unit 100 when minting the unit, and may include information such as a name of the collectible, a quality of the collectible, a date when the collectible was minted, a series number of the collectible, or a serial number uniquely identifying the collectible. Such information may be included in metadata saved on a computer database that is associated with a unique identifier of the collectible 120, such as a serial number or the barcode 115. For example, when a barcode scanner scans the barcode 115, the barcode scanner may query a database using the barcode that is scanned to retrieve metadata that is associated with the unique identifier of the collectible. While the machine-readable identifier 115 is shown here as a barcode, any identifier could be included in the case 130 of the collectible unit 100 that could be recognized by a machine, such as a Near Field Communication (NFC) device, or a Quick Response (QR) code. It should be understood that any information that is human-readable may also be configured to be recognized by a machine for identification and recognition by an electronic device. The identifiers 110 can be produced on security papers and can include holograms and used to identify, track, and catalog the collectible, among others.

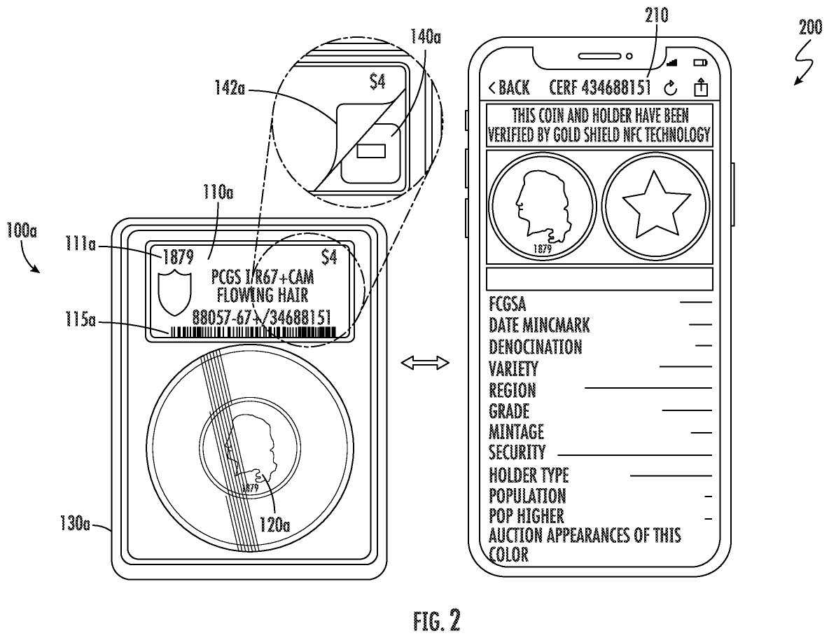

Recognizing and processing a machine-readable identifier may be performed by any suitable device in any suitable manner, such as the user computer system 200 shown in FIG. 2, which can be a smartphone, or a customized machine designed for reading such machine-readable identifier. In FIG. 2, another collectible unit 100a is shown having a collectible 120a and a set of identifiers 110a sealed within a case 130a. The set of identifiers 110a includes human-readable identifiers 111a and machine-readable identifiers 115a printed on an identification paper 142a, which can comprise security paper. Additionally, an NFC device 140a can be included, shown here as an EEPROM chip, and disposed behind the identification paper 142a. The NFC device 140a can be programmed to store metadata, security handshake, and be configured to transmit metadata, such as a unique identifier of the collectible 120a and minted or certified information about the collectible 120a that is sealed or secured within the case 130a.

The user computer system 200 may be configured to glean information about the collectible unit 100a in one or more ways. For example, the user computer system 200 may have an application installed on its memory that, when executed by a processor of the user computer system 200, may read the machine-readable identifier 115a as a barcode using an image camera of the user computer system 200, which may be used to query a database of a computer system to retrieve information about the collectible 120a. The database may reside on the Cloud or a remote server. An application installed on the user computer system 200 may also or alternatively be configured to scan the collectible unit 100a for the NFC device 140a, for example by transmitting an electromagnetic inductive current to the NFC device 140a, which may activate the NFC device 140a to transmit data saved on a memory of the NFC device 140a, such as a unique identifier of the collectible 120a, or a link to a webpage that the user can then enter, gather, and/or upload information about the collectible. In an example, the user may first be presented with a security handshake before the database can be accessed for viewing.

As used herein, a “computer system” may comprise any suitable combination of computing or computer devices, such as desktops, laptops, smart phones, blades, servers, interfaces, systems, databases, agents, peers, engines, modules, or controllers, operating individually or collectively. Computer systems and servers may comprise at least a processor configured to execute software instructions stored on a tangible, non-transitory computer readable storage medium (e.g., hard drive, solid state drive, RAM, flash, ROM, etc.). The software instructions preferably configure the computer system and server to execute the functionality as disclosed.

The NFC device 140a may be configured to store and transmit any suitable information that may be saved about a collectible held within a collectible unit, such as the collectible 120a held within the collectible unit 100a. For example, the memory of the NFC device 140a may save a unique identifier (e.g., a 7-byte UID), a lock byte with anti-tearing protection, a page for One Time Programmable (OTP) memory, a user memory (e.g., 144-bytes large user memory), and dedicated pages for authentication configuration functions (e.g., 8 dedicated pages for a password authentication, a pin configuration, a rolling code configuration, etc.).

The user computer system 200 may comprise a mobile device, such as a tablet or a smart phone, or may comprise a desktop computer or any computer system suitable to access a web browser connected to a network, such as the Internet. The user computer system may be functionally coupled to a transceiver that may be configured to gather data from a collectible unit, such as the NFC device 140a of the collectible unit 100a (e.g., via an NFC transceiver), the machine-readable identifier 115a of the collectible unit 100a (e.g., via a camera or a barcode reader), or the machine-readable identifier 115 of the collectible unit 100. An application installed on the user computer system 200 may be used to activate hardware of the user computer system 200 to gather data from the collectible unit 100a, such as a mobile device application or a web browser that executes scripts on the user computer system 200.

The user computer system 200 may have a user interface 210 configured to display content, such as metadata transmitted from the NFC device 140a to an app executing on the user computer system 200, or from a database, such as a collectible entity database, which may be queried using data received from the NFC device 140a, such as a unique identifier of the collectible. For example, the user interface 210 may display a scan or soft button that, when tapped, activates an NFC transceiver on the user computer system 200 to read metadata encoded on the NFC device 140a to retrieve metadata about the collectible 120a sealed in the case 130a.

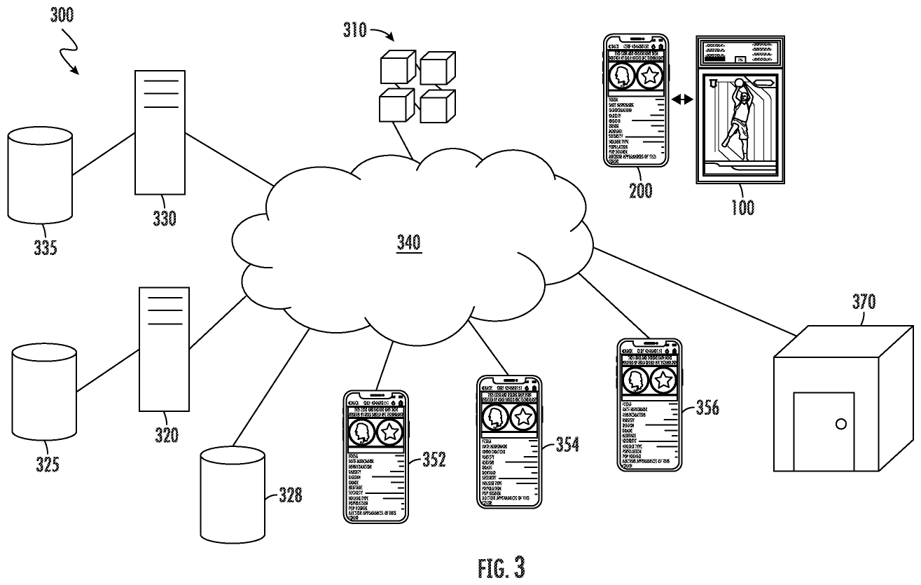

With reference now to FIG. 3, an NFT generation system 300 may comprise a blockchain network 310, an NFT token system 320, an NFT token database 325, a collectible entity system 330, a collectible entity database 335, a collectible unit 100, a user computer system 200, a user computer system 352, a user computer system 354, a user computer system 356, and a vault 370. The vault 370 can be a physical structure for housing or storing collectibles, preferably with restricted access, or can be a digital vault. The blockchain network 310 may be any blockchain network that allows an NFT to be created, such as Ethereum™ (e.g., ERC=721), FLOW™ or Tezos™.

The blockchain network 310 can allow a physical asset to be associated with an NFT, and may be configured to allow several NFTs to be generated for a single physical asset, such as a first NFT, a second NFT, a third NFT, etc. A blockchain network may be configured to limit the number of NFTs that may be generated for a physical asset, such as no more than 10 or no more than 100 NFTs, or the blockchain network may be configured to allow any number of NFTs to be generated for a single physical asset. Generally, a unique identifier of the asset needs to be provided to the blockchain network for an NFT to be generated, such as a unique identifier of a collectible (e.g., a serial number or a grading service issued unique ID), which may only be provided in a private manner that provides a unique fingerprint to the unique identifier.

In an example, the unique identifier of a collectible may be processed by an organization, such as PSA, to provide a unique identifier for the collectible that only that organization may provide. Such processing could be performed in any suitable manner, for example by hashing the unique identifier with a private key that is accessible only to the organization. For example, a user computer system 200 may read a unique identifier of a collectible unit 100 via an NFC token embedded in a case of the collectible unit 100. The unique identifier may be transmitted by the user computer system 200 to the NFT token system 320, which then hashes the unique identifier with a private key of the organization to generate a hashed unique identifier, which is then used to generate an NFT for the collectible sealed or secured in the collectible unit 100. Thus, only the hashed unique identifier may be used by the organization to generate additional NFTs for the collectible. Any other organization that wishes to generate an NFT for the collectible would need to use a different unique identifier than the organization that controls the NFT token system 320.

The NFT token system 320 may be configured to generate and track NFT tokens generated by a minting entity, such as Professional Sports Authenticator (PSA) that mints collectibles, via the blockchain network 310. The NFT token system 320 may be configured to, for example, receive requests to generate an NFT for a collectible, generate a value (i.e., price) for generating the NFT for the collectible, receive a receipt of a payment made to generate the NFT for the collectible, receive a payment made to generate the NFT for the collectible, generate one or more NFTs for a collectible via the blockchain network 310, transfer ownership of an NFT from one entity to another entity, track who owns an NFT for a collectible, generate one or more contracts or applications for an NFT, and/or track a number of NFTs that are generated for a collectible.

The NFT token system 320 may have an NFT token database 325 configured to store data and/or metadata related to NFT tokens generated for a collectible. For example, the NFT token database 325 may be configured to return a number of NFT tokens generated for a collectible when queried with a unique identifier of a collectible, may be configured to return a hashed unique identifier of a collectible when queried with a unique identifier of a collectible, may be configured to return a list of owners of NFTs when queried with a unique identifier of a collectible, or may be configured to return metadata stored regarding an NFT when queried with a unique identifier of an NFT or a collectible.

The collectible entity system 330 may be configured to track and store metadata about collectibles in the collectible entity database 335, such as collectibles that have been minted by a minting entity. For example, an entity may approach the minting entity to mint a collectible, and a user may then use the collectible entity system to store metadata about the collectible, for example a PSA rating, information about an owner of the collectible, a date the collectible was minted, and any NFTs that were generated using the collectible. The collectible entity system 330 may be configured, for example, to return metadata regarding a collectible when queried using any data related to the collectible, such as a unique identifier of the collectible, a name of the collectible, a type of the collectible, or an owner of the collectible. An entity that physically owns a collectible may use a computer system functionally connected to the collectible entity system 330, for example user computer system 200, to scan a collectible unit, such as the collectible unit 100, and query the collectible entity database 335 via the collectible entity system 330 using any data gleaned from the collectible unit 100, such as a unique identifier retrieved from an NFC packaged with the collectible unit 100, or a barcode printed on the collectible unit 100.

While the collectible entity system 330, collectible entity database 335, NFT token system 320, and the NFT token database 325 are shown as discrete units, the systems may be integrated into a single computer system or may be distributed among a plurality of computer systems as needed. For example, the NFT token system 320 and NFT token database 325 may be distributed about a cloud compute system that allows any of the user computer systems 200, 352, 354, and 356 to generate and/or trade NFT tokens via the network 340, which may be any suitable network configured to allow computer systems to communicate with one another, such as a LAN or the Internet.

The collectible entity system 330 may be used to generate an NFT for a collectible in any suitable manner. For example, a user computer system 200 may be used to receive a command from an entity to generate an NFT for a collectible. The user computer system 200 may then verify that the entity owns the collectible. For example, a user computer system 200 may be used to verify ownership of a collectible, such as the collectible unit 100. The user computer system 200 may have an application installed on the computer system that is configured to enable a user to retrieve data from the collectible unit 100, for example by scanning the machine-readable identifier 115 in FIG. 1, such as a bar code, via a camera on the user computer system 200, or for example by receiving data from an NFC chip, such as the NFC chip 142 of FIG. 2. The user computer system 200 may retrieve a unique identifier of the collectible unit 100, which indicates to the user computer system 200 that the entity controlling the user computer system 200 physically owns the collectible.

Alternatively, the entity may assert ownership of the collectible by authenticating physical ownership of the collectible using another device, such as a vault 370. The vault may include a computer system that is configured to indicate that a collectible is stored in the vault 370. For example, the vault 370 may have a storage shelf that electronically reads a collectible unit that is stored on the shelf, and may then electronically register the collectible unit to an electronic storage medium of the vault 370 configured to save data on collectibles stored in the vault 370. Alternatively, the vault 370 may have an associated database that is updated when collectibles are stored or retrieved from the vault 370, which registers ownership of collectibles stored in the vault 370 as being owned by an entity, such as a safety deposit box registry or an artwork registry.

The vault 370 may be used to authenticate physical ownership of a collectible that is stored in the vault 370. For example, the user computer system 200 may transmit a query to the vault 370 to determine whether a designated collectible is stored within the vault 370 in an area that is under control of the entity controlling the user computer system 200, or the user computer system 200 may communicate with another computer system that transmits a query to the vault 370 to determine whether a collectible is in a designated area within the vault 370. For example, an entity controlling the user computer system 200 may be configured to authenticate a user entity with the collectible entity system 330, for example by transmitting a username/password to the collectible entity system 330 to authenticate a user. The collectible entity system 330 may be configured to electronically communicate with the vault 370 to determine whether a user has stored a collectible in the vault 370. Thus, the collectible entity system 330 may transmit an authentication signal to the user computer system 200 upon verification that a designated collectible is stored in the vault 370.

Once the system authenticates that an entity of the user computer system 200 physically owns a collectible, the system may then allow that user to generate one or more NFTs for the collectible. The system may query to determine a price to be paid for generating an NFT based upon a number of NFTs that have already been generated for the collectible. For example, the NFT token system 320 may receive a request from the user computer system 200 to generate an NFT for the collectible unit 100. The user computer system 200 may verify that the entity has physical ownership of the collectible unit 100 by retrieving data from an NFC chip embedded in the collectible unit 100, and then may transmit a unique identifier of the collectible unit 100 to the NFT token system 320. The NFT token system 320 may then query the NFT token database 325 with a unique identifier of the collectible to determine how many NFTs have been generated for the collectible, and may determine that 5 NFTs, as an example, have already been generated for the collectible unit 100. The NFT token system 320 may then calculate a price to generate a new token as a function of the number of previously generated NFTs. For example, the price may be calculated as (X+1)%*(current value), where X is the number of previously generated NFTs, and (current value) is retrieved from a database of current values of collectibles, such as the collectible value database 328. Thus, here, the price may be calculated as 6% of the current value of the collectible that is retrieved from the collectible value database 328. In other examples, the number of NFTs previously generated and the current value can vary depending on the rarity and demand of the NFTs.

A collectible value database 328 may be configured to return a price for a collectible when provided with a query, such as a collectible identifier (e.g., name of a baseball card, brand, and year), and one or more quality metrics (e.g., a PSA metric). The collectible value database 328 may be configured to provide a price in any suitable currency, such as a fiat currency value (e.g., American dollars, European Union dollars), or a cryptocurrency, such as a currency traded using the blockchain network 310, and the value may be converted to another currency to determine the price to generate an NFT. For example, the collectible value database 328 may return a price in a European Currency that is then converted to a United States currency. The NFT token system 320 may transmit to the user computer system 200 the calculated price to generate a new NFT, and the entity may pay the price in any suitable manner, for example by paying the price to an account that transmits a receipt to the NFT token system 320 or may pay the price directly to the NFT token system 320, for example via an electronic wire or by authorizing a credit card payment to the NFT token system 320. Once the NFT token system 320 verifies that the transmitted price has been paid, the NFT token system 320 may generate an NFT token for the collectible unit 100.

The NFT token system 320 may be configured to generate NFT tokens having one or more contracts that are executed upon specified trigger conditions. For example, an NFT token for a collectible may have a contract that, whenever a transaction changing ownership of the NFT occurs, the entity that owned the collectible and generated the NFT receives a percentage of the transaction payment. For example, a contract may be programmed to automatically transfer 10% of a transaction price or fee to a blockchain wallet address every time ownership of the NFT changes. Such a blockchain wallet address may be called an originator account, which may be a static address that is hardcoded into an NFT contract or may be a static variable that is referenced by the NFT. For example, the originator account may be designated by the contract as an account “OR1” for the collectible saved in the collectible entity database 335. When a transaction of an NFT occurs, the corresponding NFT contract may reference the collectible entity database 335 and transfer 10% of the transaction price to the address saved as OR1 for the collectible.

The system may be configured to generate a different contract for each NFT token generated for a collectible. For example, a first entity may have physical ownership of a collectible unit to generate a first NFT token, and the NFT token system 320 may be configured to generate a first contract for the first NFT token to transfer a portion of the transaction price to an address associated with the first entity. Physical ownership of the collectible unit may then be transferred to a second entity, who then generates a second NFT token. The NFT token system 320 may then be configured to generate a second contract for the second NFT token to transfer a portion of the transaction price associated with the second entity. Thereafter, when the first NFT token changes ownership, the first contract may automatically transfer a portion of the transaction price to the first blockchain address associated with the first entity, and when the second NFT token changes ownership, the second contract may automatically transfer a portion of the transaction price to the second blockchain address associated with the second entity.

Once an NFT token is generated, ownership of the NFT token may change without physical ownership of the collectible unit 100 changing. For example, an entity in control of the user computer system 200 may wish to transfer ownership of a newly generated NFT token to an entity in control of the user computer system 352 by conducting a transaction using the user interface of the user computer system 200. Such ownership transfers may be conducted directly using the blockchain network 310, or via a marketplace, such as a marketplace hosted by the NFT token system 320 or the collectible entity system 330. The ownership transfers are generally recorded in one or more ledgers of the blockchain network 310, which certifies transactions, contracts, and ownership transfers between entities.

The system 300 may also be configured to transfer physical ownership of a collectible unit. Such transfers may be particularly advantageous where a collectible unit is stored in a vault, such as the vault 370. The collectible entity system 330 may be configured to transfer physical ownership of a collectible unit stored in the vault 370 remotely, for example by associating a unique identifier of a new owner to the collectible unit. A transaction to change physical ownership of a collectible unit stored in the vault 370 may be completed using any suitable marketplace that is configured to create and accept transactions, and to transfer ownership of an item stored in the vault 370, such as the collectible entity system 330. For example, if a collectible card worth $100,000 is stored in the vault 370, an authenticated owner using the user computer system 200 may authorize a sale of the collectible card to an authenticated entity using the user computer system 354. The transaction may be mediated by the collectible entity system 330, which is configured to transfer ownership of the collectible unit upon receiving confirmation that the $100,000 payment has been made by the authenticated entity. NFTs may also be used to conduct transactions. For example, if NFTs of the collectible unit are trading for 1/100 of the value of the collectible unit, the authenticated owner may allow the authenticated entity to pay for the collectible unit using 100 NFTs of the collectible unit.

It will be appreciated from the foregoing that the NFT generation systems and methods disclosed herein can be adapted to a wide variety of uses systems, and that systems employing the disclosed features can be operated to generate NFTs for collectibles as will be suitable to different applications and circumstances. It will therefore be readily understood that the specific embodiments and aspects of this disclosure described herein are exemplary only and not limiting, and that a number of variations and modifications will suggest themselves to those skilled in the pertinent arts without departing from the spirit and scope of the disclosure.

What is claimed is:

1. A method of generating a non-fungible token (NFT) for a collectible, comprising:
receiving a request to generate a token for the collectible from a requesting entity;
authenticating physical ownership of the collectible by the requesting entity using a vault authentication device;
retrieving a number of previously generated tokens for the authenticated collectible from a non-fungible token database;
retrieving a current value of the collectible from a collectible value database;
generating a fiat currency value of the non-fungible token as a function of the number of previously generated tokens for the authenticated collectible and the current value of the collectible;
generating the non-fungible token in a blockchain network as a function of the fiat currency value;
incrementing the number of previously generated tokens for the authenticated collectible in the non-fungible token database; and
assigning digital ownership of the non-fungible token to the requesting entity in the blockchain network.

2. The method of claim 1, further comprising authenticating the requesting entity in a collectible entity database that associates the requesting entity with an address in the blockchain network.

3. The method of claim 1, wherein the vault authentication device comprises a physical vault that dynamically records a presence of the collectable within the physical vault.

4. The method of claim 1, wherein the vault authentication device comprises a wireless reader that records a unique identifier of an NFC (Near Field Communication) device embedded within a sealed case of the collectible.

5. The method of claim 1, wherein generating the fiat currency value comprises an increased percentage of the current value of the collectible when the number of previously generated tokens increases.

6. The method of claim 1, wherein generating the fiat currency value comprises generating a value higher than the current value of the collectible when the number of previously generated tokens exceeds a threshold value.

7. The method of claim 1, wherein generating the non-fungible token in the blockchain network further comprises adding an upgrade metadata flag to a ledger for the non-fungible token as a function of a random number generator.

8. The method of claim 1, further comprising minting the collectible by assigning a grade and a unique identifier to the collectible and sealing an indicator of the grade and the unique identifier with the collectible in a sealed case for the collectable.

9. The method of claim 8, further comprising generating a current value of the collectible as a function of the assigned grade of the minted collectible.

10. The method of claim 1, wherein generating the non-fungible token in the blockchain network further comprises generating a contract for the non-fungible token that automatically transfers a portion of a transaction price to an originator account when the non-fungible token is transferred to a new owner.

11. The method of claim 1, further comprising:
receiving a request for the collectible from a delivery entity;
authenticating digital ownership of a number of non-fungible tokens generated using the authenticated collectible against a ledger of the blockchain network; and
delivering physical ownership of the collectible to the delivery entity upon authentication of the digital ownership.

12. A system for generating a non-fungible token for a unique collectible, comprising:
a vault authentication device that authenticates physical ownership of the collectible by a requesting entity;
a non-fungible token database that tracks non-fungible tokens generated for the collectible in a blockchain network, wherein each non-fungible token identifies an owner and the unique collectible that the non-fungible token is generated for;
a non-fungible token generation system, configured to:
authenticate physical ownership of the collectible by a requesting entity using the vault authentication device;
retrieve a number of previously generated tokens for the authenticated collectible from the non-fungible token database;
retrieve a current value of the collectible from a collectible value database;
generate a fiat currency value of the non-fungible token as a function of the number of previously generated tokens for the authenticated collectible and the current value of the collectible;
generate the non-fungible token for the unique collectible in a blockchain network as a function of the fiat currency value;
associate the non-fungible token with the collectible in the non-fungible token database; and
assign digital ownership of the non-fungible token to the requesting entity in the blockchain network.

13. The system of claim 12, further comprising a collectible entity database that associates the requesting entity with an address in the blockchain network, wherein the vault authentication device authenticates the requesting entity using the collectible entity database.

14. The system of claim 12, wherein the non-fungible token generation system is further configured to generate the fiat currency value of the non-fungible token as an increased percentage of the current value of the collectible when the number of previously generated tokens increases.

15. A method of generating non-fungible tokens for a collectible, comprising:
assigning a unique identifier to the collectible;
sealing an NFC device within a sealed case that holds the collectible;
authenticating physical ownership of the collectible at the first time by the requesting entity using a vault authentication device to retrieve the unique identifier from the NFC device;
receiving a request to generate a first token for the collectible from a requesting entity at a first time;
retrieving a first value of the collectible at a first time from a collectible value database;
generating a first fiat currency value of the first non-fungible token as a function of a first percentage of the first value of the collectible;
generating a first non-fungible token in a blockchain network upon receipt of a transaction receipt confirming payment of the first fiat currency value for the first non-fungible token;
receiving a request to generate a second token for the collectible from the requesting entity at a second time;
retrieving a second value of the collectible at a second time from the collectible value database;
generating a second fiat currency value of the second non-fungible token as a function of a second percentage of the second value of the collectible, wherein the second percentage is larger than the first percentage;
generating a second non-fungible token in the blockchain network upon receipt of a transaction receipt confirming payment of the second fiat currency value for the second non-fungible token.

16. The method of claim 15, wherein the NFC device is further configured to transmit a set of metadata associated with the collectible to the vault authentication device.

17. The method of claim 16, wherein generating the first non-fungible token in the blockchain network comprises recording the unique identifier and the set of metadata in a ledger for the first non-fungible token of the blockchain network.

18. The method of claim 15, wherein generating the first non-fungible token in the blockchain network comprises recording a number of non-fungible tokens created for the collectible in a ledger for the first non-fungible token of the blockchain network.

19. The method of claim 15, wherein generating the second non-fungible token in the blockchain network comprises recording a number of non-fungible tokens created for the collectible in a ledger for the first non-fungible token of the blockchain network and a ledger for the second non-fungible token of the blockchain network.

20. The method of claim 15, wherein generating the first non-fungible token in the blockchain network further comprises adding an upgrade metadata flag to a ledger for the non-fungible token as a function of a random number generator.
